(19) United States
(12) Patent Application Publication
(10) Pub. No.: US 2005/0128937 A1
(43) Pub. Date: Jun. 16, 2005

(54) Determination of correlation in the frequency domain

(75) Inventor: David Akopian, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/734,077

(22) Filed: Dec. 11, 2003

(51) Int. Cl. H04J 11/00

(52) U.S. Cl. 370/210

(57) ABSTRACT

The invention relates to a device for determining in the frequency domain the correlation between a code modulated signal and a replica code sequence in parallel for various relative shifts between the code modulated signal and the replica code sequence. The device comprises a common memory arranged for storing in sequence different intermediate results in determining the correlation. The intermediate results including at least samples resulting at various stages of a time to frequency transform used for transforming samples of the code modulated signal into the frequency domain and samples resulting at various stages of a frequency to time transform used for transforming obtained correlation results into the time domain. The invention relates equally to a corresponding system, to a corresponding method and to a corresponding software program product.

### FIELD OF THE INVENTION

The invention relates to a device, a system, a method and a software program product for determining in the frequency domain the correlation between a code modulated signal and a replica code sequence in parallel for various relative shifts between the code modulated signal and the replica code sequence.

### BACKGROUND OF THE INVENTION

A correlation between a code modulated signal and a replica code sequence has to be determined for example for the acquisition of code modulated signals at a CDMA (Code Division Multiple Access) spread spectrum receiver.

For a spread spectrum communication in its basic form, a data sequence is used by a transmitting unit to modulate a sinusoidal carrier, and then the bandwidth of the resulting signal is spread to a much larger value. For spreading the bandwidth, the single-frequency carrier can be multiplied for example by a high-rate binary pseudo-random noise (PRN) code sequence comprising values of −1 and 1, which code sequence is known to a receiver. Thus, the signal that is transmitted includes a data component, a PRN component, and a sinusoidal carrier component. A PRN code period comprises typically 1023 chips, the term chips being used to designate the bits of the code conveyed by the transmitted signal, as opposed to the bits of the data sequence.

A well known system which is based on the evaluation of such code modulated signals is GPS (Global Positioning System). In GPS, code modulated signals are transmitted by several satellites that orbit the earth and received by GPS receivers of which the current position is to be determined. Each of the satellites transmits two microwave carrier signals. One of these carrier signals L1 is employed for carrying a navigation message and code signals of a standard positioning service (SPS). The L1 carrier signal is modulated by each satellite with a different C/A (Coarse Acquisition) Code known at the receivers. Thus, different channels are obtained for the transmission by the different satellites. The C/A code, which is spreading the spectrum over a 1 MHz bandwidth, is repeated every 1023 chips, the epoch of the code being 1 ms. The carrier frequency of the L1 signal is further modulated with the navigation information at a bit rate of 50 bit/s. The navigation information, which constitutes a data sequence, can be evaluated for example for determining the position of the respective receiver.

A receiver has to have access to a synchronized replica of the modulation code which was employed for a received code modulated signal, in order to be able to de-spread the data sequence of the signal. To this end, a synchronization has to be performed between the received code modulated signal and an available replica code sequence. Usually, an initial synchronization called acquisition is followed by a fine synchronization called tracking. During signal acquisition, a replica PRN code is synchronized, with a small timing offset, with the code conveyed by the received signal either for the first time or after losing a previously acquired signal. In both case, the faster the acquisition is performed, the faster the position of the receiver can be computed.

In both synchronization scenarios, acquisition and tracking, a correlator is used to find the best match between the replica code sequence and the received signal and thus to find their relative shift called code phase.

Two main types of correlators have been suggested so far. A first type of correlators performs a direct correlation of the replica code sequence and the received signal in the time domain. This implies that a dedicated processing step is carried out for each possible code phase. In case there is a large number of code phases to check, the computational burden is significant, especially for software based receivers. A second type of correlators relies on frequency domain acquisition techniques employing e.g. Discrete Fourier Transforms (DFT), which enable a parallel processing for all possible code phases and thereby a faster synchronization. DFT algorithms are called Fast Fourier Transforms (FFT).

FIG. 1 illustrates a known FFT based circular correlation in the frequency domain which may be carried out by a correlator or, equivalently, a matched filter. To simplify the illustration, the modulation code is supposed to comprise eight samples. In practice, the code will usually comprise a larger number of samples, e.g. 1024 samples. First, a vector 11 with eight samples of a received code modulated signal is provided to the correlator. Each sample in FIG. 1 is indicated by a small circle. The correlator performs an FFT 12 of the provided vector 11, resulting in another vector 13 with eight samples. Further, the correlator retrieves or calculates a conjugate 14 of the FFT of a vector comprising eight samples of an available replica code sequence. The FFT vector 13 of the received signal and the conjugate 14 of the FFT of the replica code sequence are then multiplied pointwise 15. For the resulting vector 16 of again eight samples, an Inverse Fast Fourier Transform (IFFT) 17 is performed, which results again in a vector 18 comprising eight samples. Each sample of the output IFFT vector 18 corresponds to a correlation value for another one of all possible circular shifts. The output IFFT vector 18 may comprise for example the sample values [0.5 7.8 2.3 5.3 2.9 3.4 4.5 0.7] which are associated in this order to the code phases [0 1 2 3 4 5 6 7]. In presented example, the maximal value of the output samples is 7.8, thus the found code phase is 1. This means that the replica code is shifted by one sample relative to the received code of the code modulated signal.

A well known implementation of an FFT is the Decimation-In-Frequency (DIF) FFT. DIF FFT algorithms have been described for example by P. Duhamel and M. Vetterli in: “Fast Fourier Transforms: A Tutorial Review and a State of the Art”, Signal Processing, vol. 19, no. 4, pp. 259-299, April 1990, and by A. Oppenheim, R. Schafer. in: “Discrete-Time Signal Processing”, Prentice-Hall, International, Inc, 1989.

DIF FFT algorithms employ butterfly stages, which, for use in a matched filter, have to be followed by a stage reordering the resulting data. Correspondingly, DIF IFFT algorithms employ butterfly stages, which, for use in a matched filter, have to be preceded by a stage reordering the input data. Such a reordering has the disadvantage that it requires either additional memory within the matched filter architecture or a communication with a host processor resulting in processing delays.

### SUMMARY OF THE INVENTION

It is an object of the invention to optimize the memory usage when determining the correlation between a code modulated signal and a replica code sequence in the frequency domain.

A device is proposed for determining in the frequency domain the correlation between a code modulated signal and a replica code sequence in parallel for various relative shifts between the code modulated signal and the replica code sequence. The proposed device comprises a common memory arranged for storing in sequence different intermediate results in determining the correlation. These intermediate results include at least samples resulting at various stages of a time to frequency transform used for transforming samples of the code modulated signal into the frequency domain and samples resulting at various stages of a frequency to time transform used for transforming obtained correlation results into the time domain.

The proposed device can be for example a receiver receiving the code modulated signal from a beacon or a mobile terminal comprising such a receiver. In the latter case, the correlation can be determined either in the receiver or in the mobile terminal. The proposed device can equally be a network element of a communication network receiving samples of a code modulated signal from a receiver receiving the code modulated signals from a beacon. In this case, the network element may determine the correlation for the receiver. In either of these exemplary devices, the correlation can be determined in particular by a matched filter including the common memory. The proposed device can also be given for example by such a matched filter itself.

Further, a system is proposed for determining in the frequency domain the correlation between a code modulated signal and a replica code sequence in parallel for various relative shifts between the code modulated signal and the replica code sequence. The proposed system comprises a receiver with a receiving component for receiving a code modulated signal from a beacon and with a transmitting component for providing samples of the code modulated signal. The proposed system comprises in addition a device with a receiving component for receiving samples of a code modulated signal provided by the receiver and a common memory arranged for storing in sequence different intermediate results in determining the correlation. This common memory corresponds to the common memory of the separately proposed device.

The proposed system can comprise for example a receiver which is combined with a mobile terminal able to communicate with a communication network and a device which is a network element of this communication network.

Further, a method is proposed for determining in the frequency domain the correlation between a code modulated signal and a replica code sequence in parallel for various relative shifts between the code modulated signal and the replica code sequence. The proposed method comprises applying a time to frequency transform on samples of the code modulated signal for transforming the samples of the code modulated signal into the frequency domain, and storing intermediate results resulting at various stages of the time to frequency transform in a memory. The proposed method further comprises applying a frequency to time transform on obtained correlation results for transforming the obtained correlation results into the time domain, and storing intermediate results resulting at various stages of the frequency to time transform in this same memory.

Finally, a software program product is proposed, in which a software code is stored for determining in the frequency domain the correlation between a code modulated signal and a replica code sequence in parallel for various relative shifts between the code modulated signal and the replica code sequence. When running in a processor, the software code realizes the steps of the proposed method.

The invention proceeds from the consideration that a single memory space can be shared at least for time to frequency transform and frequency to time transform operations. The time to frequency transform and the frequency to time transform can be for example, though not exclusively, an FFT and an IFFT, respectively.

It is an advantage of the invention that it allows to optimize a correlation employed for example in the acquisition of a code modulated signal.

It is in particular an advantage of the invention that the memory space is used optimally by employing a single memory for various processing steps. Thereby, the size of the total required memory space can be reduced to one half.

In an embodiment of the invention, the same memory space is shared in addition for storing the samples of the code modulated signal before it is transformed into the frequency domain.

In a further embodiment of the invention using DIF FFT and DIF IFFT, a structure is employed, in which the data reorderings specific to DIF FFT and DIF IFFT algorithms are not needed for determining the correlation. This is achieved by an equivalent reordering of the frequency domain replica samples which are used in the correlation computations. These frequency domain replica samples can either be given by the conjugate of the replica samples transformed into the frequency domain or by the time to frequency transform of inverted replica samples. Moving the reordering in such a manner enables either to avoid reordering operations in a matched filter unit or it enables the continuous computation of butterfly operations without the need to communicate with a host processor between the DIF FFT and the DIF IFFT stages.

In a further embodiment of the invention, a single processing element is used for DIF FFT butterfly operations and DIF IFFT butterfly operations, which comprise only additions. For the DIF FFT, the additionally required multiplications to coefficients are then performed by a multiplier after the butterfly operations in the processing element, while for DIF IFFT, the multiplications to coefficients are performed by a multiplier before the butterfly operations in the processing element. Such a combined DIF FFT and DIF IFFT structure reduces in addition the required processing elements and allows to optimize the data flow.

A further embodiment of the invention exploits the properties of a DIF FFT and a DIF IFFT. The last stage of a DIF FFT and the first stage of a DIF IFFT require no multiplications, i.e. only the additions of the butterfly operations have to be applied. Therefore, the multiplier associated to the DIF FFT can be used in the last FFT stage for multiplying the resulting samples in addition to the employed frequency domain replica samples. Alternatively, the multiplier associated to the DIF IFFT can be used in the first IFFT stage for multiplying the resulting samples in addition to the employed frequency domain replica samples. Thus, the multiplications to the frequency domain replica samples are performed within a butterfly stage. This allows to further optimize the employed architecture by saving in addition one multiplier.

In the case of a hardware implementation, a computational stage can be saved by merging the first stage of a frequency to time transform or the last stage of a time to frequency transform with the multiplications of the frequency domain replica samples to the samples resulting in the time to frequency transform. This allows to reduce the amount of calculations, depending on the transform size, for example by about 10%.

If the time to frequency transform, the replica multiplications and the frequency to time transform are computed in a single flow pattern, as proposed for some embodiments of the invention, the data flow will be simplified compared to conventional computations. Conventional computations perform time to frequency transform computations using an external memory to save the results, multiplications of the replica samples to the samples resulting in the time to frequency transform, and then frequency to time transform computations. To perform all three stages, a control unit is required which distributes the tasks between the different stages. The invention, in contrast, allows to perform all three stages in one data flow pattern making use of butterfly operations.

The invention can be employed in particular for supporting the acquisition of a code modulated signal received at a receiver, for example of a GPS signal received at a GPS receiver or any other code modulated satellite or beacon signal received by some other kind of receiver.

The invention can be implemented in hardware and/or in software. The actual implementation is advantageously adapted to the implementation of the general acquisition algorithm.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not drawn to scale and that they are merely intended to conceptually illustrate the structures and procedures described herein.

### BRIEF DESCRIPTION OF THE FIGURES

FIG. 1 is a diagram illustrating a known circular correlation in the frequency domain based on FFT;

FIG. 2 schematically presents a GPS receiver in which the invention can be implemented;

FIG. 3 schematically shows a block diagram of an embodiment of a DIF FFT based matched filter according to the invention, which may be employed in the receiver of FIG. 2;

FIG. 4 to FIG. 7 are diagrams illustrating the relation of the DIF FFT based matched filter of FIG. 3 to a known DIF FFT based matched filter;

FIG. 8 is a flow chart illustrating the operation of the matched filter of FIG. 3; and

FIG. 9 schematically presents a system in which the matched filter of FIG. 3 could be employed alternatively.

### DETAILED DESCRIPTION OF THE INVENTION

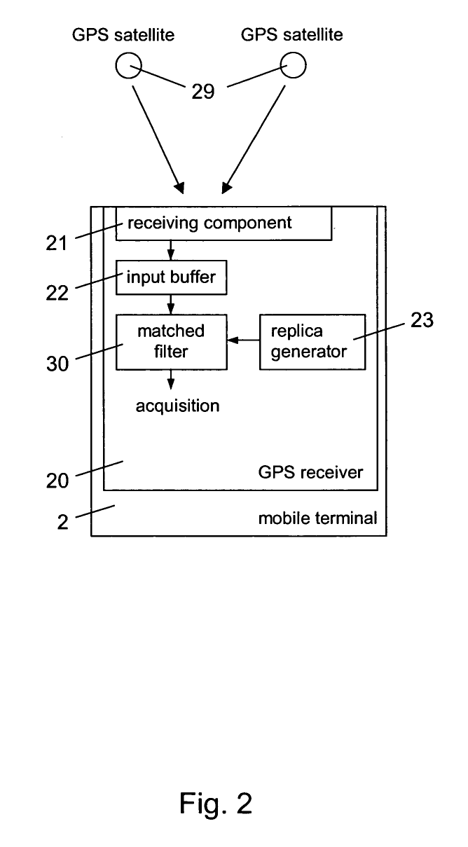

FIG. 2 presents by way of example a GPS receiver 20 in which the invention can be implemented for supporting the acquisition of satellite signals. The GPS receiver 20 may be part of a mobile terminal 2 or an autonomous GPS receiver.

The GPS receiver 20 includes a receiving component 21 for receiving a code modulated signals transmitted by a GPS satellite 29 and an input buffer 22 for storing samples originating from a received satellite signal. The GPS receiver 20 further includes an FFT replica generator 23 for generating replica samples and a matched filter 40 for performing a correlation between samples from the input buffer 22 and replica samples provided by the FFT replica generator 23. The resulting correlation values are output by the matched filter 30 for enabling the final acquisition of the received satellite signal in a well known manner.

Further components of the GPS receiver 20, which are not shown, may correspond to any components of known GPS receivers.

In the following, an exemplary structure of the matched filter 30 and its operation will be described in more detail.

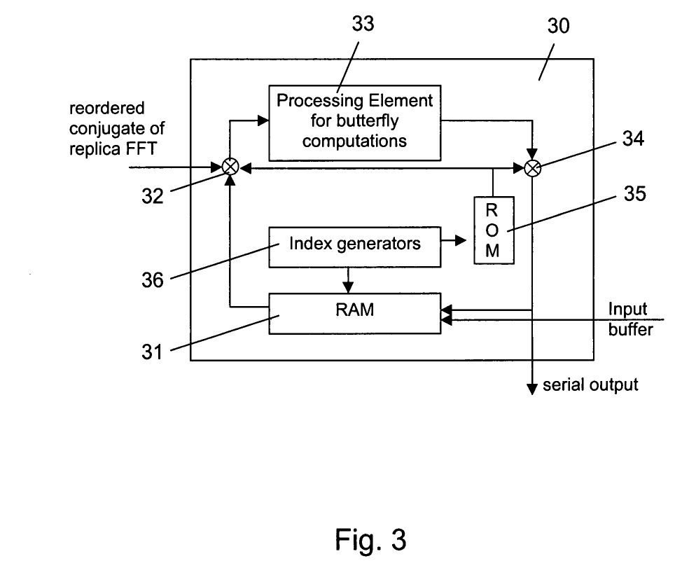

FIG. 3 is a schematic block diagram of the architecture of the matched filter 30.

The matched filter 30 comprises a RAM (random access memory) 31. The output of the input buffer 22 of the GPS receiver 20 of FIG. 2 is connected to a first input of the RAM 31. The output of the RAM 31 is connected via a first multiplier 32 to a processing element for butterfly computations 33. The output of the processing element 33 is connected via a second multiplier 34 on the one hand to a second input of the RAM 31 and on the other hand to the output of the matched filter 30. The matched filter 30 further comprises a ROM (read only memory) 35 having an output which is connected to the first multiplier 32 and to the second multiplier 34. An index generator 36 has a controlling access as well to the RAM 31 as to the ROM 35. The output of the FFT replica generator 23 of the GPS receiver 20 of FIG. 2 is also connected to the first multiplier 32.

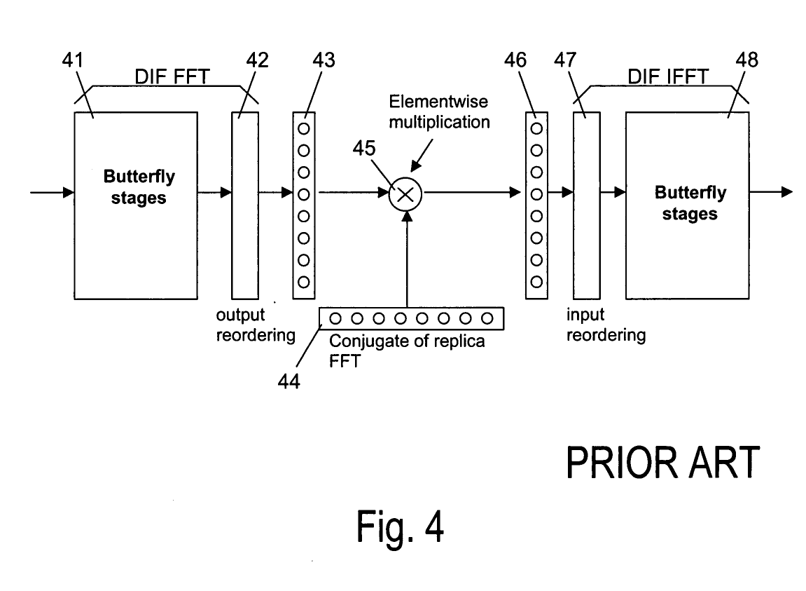

In the following, first the relation between a conventional DIF FFT based correlation and the DIF FFT based correlation in the matched filter of FIG. 3 will be explained with reference to FIGS. 4 to 7.

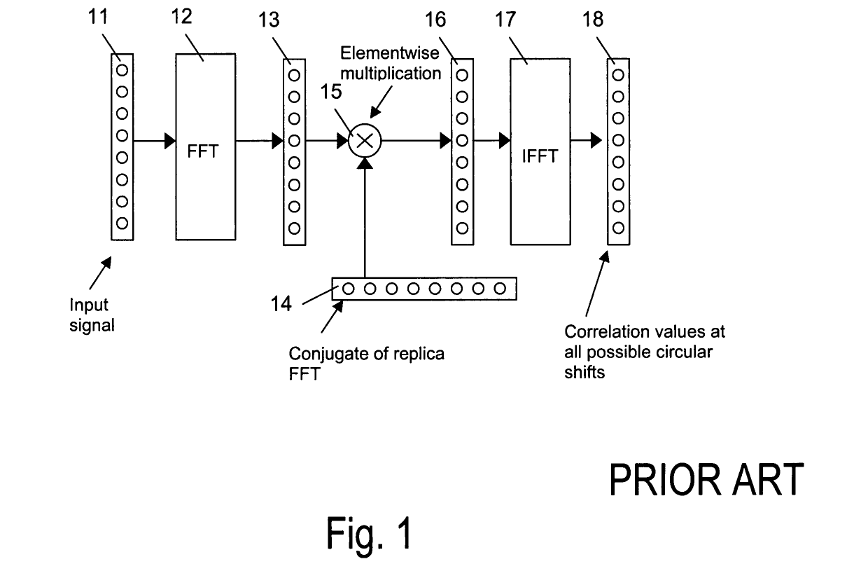

FIG. 4 is a diagram illustrating a conventional DIF FFT based correlation. It corresponds exactly to the circular correlation described above with reference to FIG. 1. In this case, however, the FFT 12 is specified to be a DIF FFT and the IFFT 17 is specified to be a DIF IFFT. For the DIF FFT, an input vector S is subjected to butterfly stages 41, which are followed by an output reordering 42 resulting in FFT vector 43. The FFT vector 43 of the received signal and the conjugate of an FFT vector of a replica code sequence 44 are then multiplied pointwise 45, resulting in vector 46. The DIF IFFT applies first an input reordering 47 to vector 46, followed by butterfly stages 48. The employed DIF FFT and DIF IFFT algorithms are described for example in the above cited documents “Fast Fourier Transforms: A Tutorial Review and a State of the Art” and “Discrete-Time Signal Processing”.

The DIF algorithm factors the FFT matrix to orthogonal components. Mathematically, the FFT factorization can be written as:
T_{FFT}=RₒᵤₜTₙTₙ₋₁ . . . T₁,T (1)
where T_{FFT} is the FFT matrix, where Rₒᵤₜ is the output permutation, and where Tₙ,Tₙ₋₁, . . . ,T₁ are the matrices computed at various stages of the transform.

Each stage matrix Tᵢ, with i=1 to n, can be presented as:
Tᵢ=RᵢₒᵤₜDᵢRᵢᵢₙ, (2)
where Rᵢₒᵤₜ and Rᵢᵢₙ are reordering matrices and where Dᵢ is a block diagonal matrix with blocks representing the butterfly matrices, i.e. Dᵢ=ⱼ^{⊕}Bᵢ^{j}. The operator ⊕ is used for building block diagonal matrices. For example, if A and B are matrices, then

$$A ⊕ B = ( \begin{matrix}A & 0 \\ 0 & B\end{matrix} ) .$$

In equation (2), Dᵢ is thus composed of the blocks Bᵢ^{j} representing the butterfly matrices, that is,

$${D}_{i} = ( \begin{matrix}{B}_{i}^{1} & 0 & . & 0 \\ 0 & {B}_{i}^{2} & . & 0 \\ . & . & . & . \\ 0 & 0 & . & {B}_{i}^{J}\end{matrix} ) ,$$

if j=1 to J. For radix-2 and radix-4 DIF butterflies, these blocks Bᵢ^{j} will be of the form:

$$\begin{matrix}{B}_{2}^{DIF} = ( \begin{matrix}1 & 0 \\ 0 & {W}_{N}^{k}\end{matrix} ) ( \begin{matrix}1 & 1 \\ 1 & - 1\end{matrix} ) & ( 3 ) \\ and & \\ {B}_{4}^{DIF} = ( \begin{matrix}1 & 0 & 0 & 0 \\ 0 & {W}_{N}^{k} & 0 & 0 \\ 0 & 0 & {W}_{N}^{2 K} & 0 \\ 0 & 0 & 0 & {W}_{N}^{3 K}\end{matrix} ) ( \begin{matrix}1 & 1 & 1 & 1 \\ 1 & - j & - 1 & j \\ 1 & - 1 & 1 & - 1 \\ 1 & j & - 1 & - j\end{matrix} ) , & ( 4 )\end{matrix}$$

respectively, where k is an integer depending on both indices i, j of Bᵢ^{j}. Thus, the respective second matrix is responsible for the actual butterfly operation, while the respective first matrix is responsible for multiplying the samples of a vector, to which the respective butterfly stage is applied, with desired coefficients. It has to be noted that for the last stage matrix Tₙ, the coefficients W_{N}^{k}, W_{N}^{2k}, W_{N}^{3k} in the respective first matrix are all equal to one, meaning that no multiplications are required.

The factorization for the IFFT matrix can be obtained by transposing and conjugating each factor of the FFT matrix T_{FFT} in equation (1) and by then reversing their order. The factorization of the IFFT matrix T_{IFFT} can thus be written as:
T_{IFFT}=T′_{FFT}=T′_{FFT}=T′₁T′₂ . . . T′ₙR′ᵢₙ, (5)
where T′₁,T′₂, . . . ,T′ₙ is the notation of the matrices computed at each stage of the IFFT, and where R′ᵢₙ is the input permutation, which corresponds to the transpose of Rₒᵤₜ. The transposition of the stage matrices affects also the butterfly matrices. The transposed stage matrices T′ᵢ, with i=1 to n, are given by:
T′ᵢ=R′ᵢᵢₙD′ᵢR′ᵢₒᵤₜ=R′ᵢᵢₙ_{ⱼ}^{⊕}(Bᵢ^{j})′R′ᵢₒᵤₜ. (6)

The transposed form of the radix-2 and radix-4 DIF blocks representing the butterfly matrices, respectively, is given by the following equations:

$$\begin{matrix}{( {B}_{2}^{DIF} )}^{′} = ( \begin{matrix}1 & 1 \\ 1 & - 1\end{matrix} ) ( \begin{matrix}1 & 0 \\ 0 & {W}_{N}^{- k}\end{matrix} ) & ( 7 ) \\ and & \\ {B}_{4}^{DIF} = ( \begin{matrix}1 & 1 & 1 & 1 \\ 1 & j & - 1 & - j \\ 1 & - 1 & 1 & - 1 \\ 1 & - j & - 1 & j\end{matrix} ) ( \begin{matrix}1 & 0 & 0 & 0 \\ 0 & {W}_{N}^{- k} & 0 & 0 \\ 0 & 0 & {W}_{N}^{- 2 k} & 0 \\ 0 & 0 & 0 & {W}_{N}^{- 3 k}\end{matrix} ) , & ( 8 )\end{matrix}$$

where k is an integer. The transposition means in fact that in a butterfly stage, j is replaced by −j and that the coefficients are conjugated according to the relation W_{N}^{k}→W_{N}^{-k}. In addition, the order of multiplying to coefficients and additions is changed. Thus here, the respective first matrix is responsible for the actual butterfly operation, while the respective second matrix is responsible for multiplying the samples of a vector, to which the respective butterfly stage is applied, with desired coefficients. It has to be noted that for the first stage matrix T′ₙ, the coefficients W_{N}^{-k}, W_{N}^{-2k}, W_{N}^{-3k} in the respective first matrix are all equal to one, that is no multiplications are required.

Now, a circular convolution matrix composed of the replica and its circular shifts is denoted as M. With the input signal vector being denoted as S, the circular correlation is then given by M·S. Further, a diagonal matrix with the diagonal composed of the conjugated FFT of the replica signal 44 or the FFT of the inverted replica signal is denoted as C.

Then the entire matched filtering operation can be presented in the following way:
M·S=T′_{FFT}·C·T_{FFT}S=T′₁T′₂ . . . T′ₙR′ᵢₙ·C·RₒᵤₜTₙTₙ₋₁ . . . T₁·S (9)

Based on this equation, a new diagonal matrix Cᵣ can be defined with:
Cᵣ=R′ᵢₙ·C·Rₒᵤₜ, (10)
where the diagonal of matrix Cᵣ is formed by the conjugate of the replica FFT samples reordered according to the elements of R′ᵢₙ and Rₒᵤₜ. Thus, it is no necessary to reorder the outputs of the FFT and the inputs of the IFFT, as indicated in FIG. 4. Instead, only the conjugate of the replica FFT samples can be reordered, resulting in the following equation for the matched filtering operation:
M·S=T′_{FFT}·C·T_{FFT}S=T′₁T′₂ . . . T′ₙCᵣ·TₙTₙ₋₁ . . . T₁·S (11)

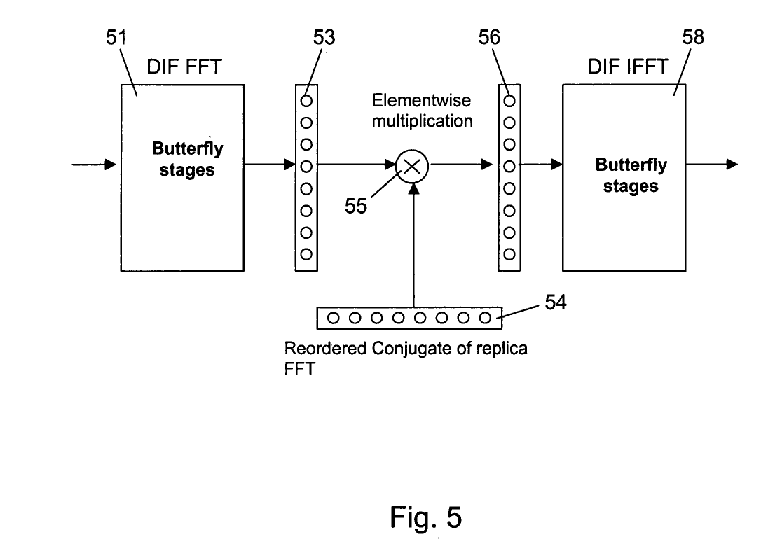

The shifting of the reordering to the conjugate of the replica FFT samples is illustrated in FIG. 5. FIG. 5 is identical to FIG. 4, except that the output reordering stage 42 and the input reordering stage 47 of the DIF FFT and the DIF IFFT, respectively, were removed. Instead, the conjugate of replica FFT 44 provided for the multiplication 45 is substituted by a reordered conjugate of the replica FFT 54, the reordering being carried out in accordance with equation (10) by an FFT replica generator 23. The reordered conjugate of the replica FFT 54 corresponds thus to the diagonal elements of matrix Cᵣ. The result 56 of the multiplications 55 of vector 54 with the output vector 53 of the butterfly stages 51 is provided directly to the butterfly stages 58 for the DIF IFFT.

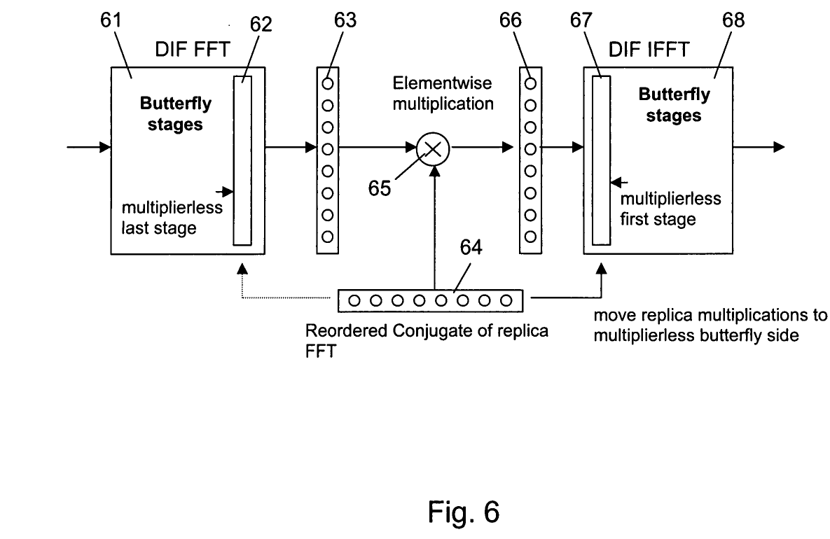

As mentioned above, the last butterfly stage of the DIF FFT and the first butterfly stage of the DIF IFFT are multiplierless. This means that the elementwise multiplications 55 of the output of the DIF FFT 53 to the elements 54 of the diagonal of replica matrix Cᵣ can be realized advantageously either as a part of the last butterfly stage Tₙ of the DIF FFT or as part of the first butterfly stage T′ₙ of the DIF IFFT without requiring an additional multiplier. This further restructuring is illustrated in FIG. 6. FIG. 6 is identical to FIG. 5, except that it is indicated that the multiplications 65 of the output 63 of the butterfly stages 61 of the DIF FFT with the reordered conjugate of the replica FFT 64 resulting in vector 66 can be moved to the multiplierless first stage 67 of the butterfly stages 68 DIF IFFT. The alternative of moving the multiplications 65 with the reordered conjugate of the replica FFT 64 to the multiplierless last stage 62 of the butterfly stages 61 of the DIF FFT is indicated with an arrow with dotted lines.

In case the multiplication with matrix Cᵣ is moved to the first butterfly stage 67 of the DIF IFFT, CᵣT′ₙ in equation (11) can be denoted as \tilde{T}′ₙ. As a result, the matched filter computations consist completely of butterfly stages:
M·S=T′_{FFT}·C·T_{FFT}S=T′₁T′₂ . . . \tilde{T}′ₙTₙ₋₁ . . . T₁·S. (12)

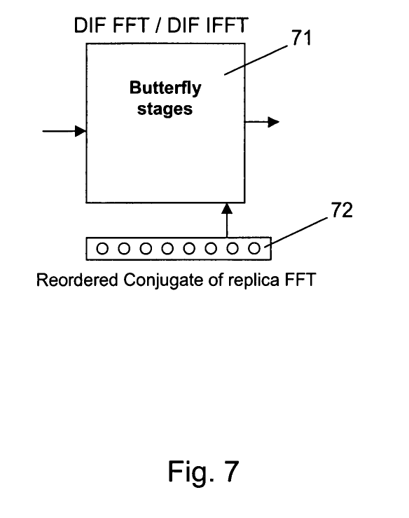

This is illustrated by FIG. 7, which presents a matched filter comprising only a block 71 with the DIF FFT and DIF IFFT butterfly stages, to which an input vector S and a reordered conjugate of a replica FFT 74 are provided. This block 71 can be realized for example like the matched filter presented in FIG. 3.

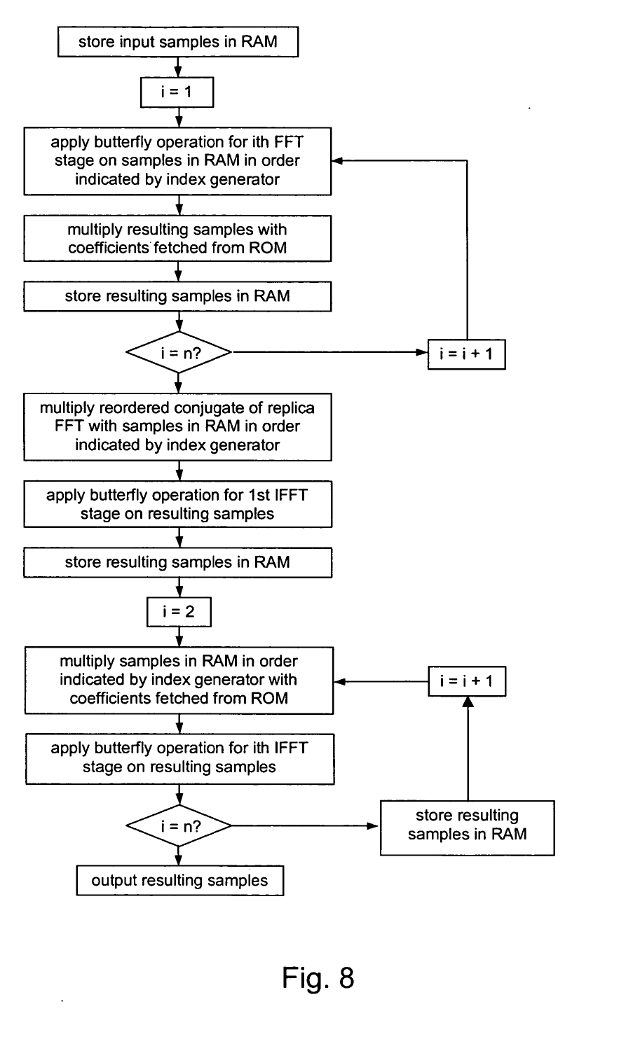

The operation of the matched filter of FIG. 3 when implemented in the GPS receiver 20 of FIG. 2 will now be explained with reference to the flow chart of FIG. 8.

The FFT replica generator 23 of the GPS receiver 20 is able to generate a replicate code sequence for various GPS satellites, to create from the samples of a respective replica code sequence the diagonal elements of a diagonal matrix C with the diagonal composed of the conjugated FFT of the replica or the FFT of the inverted replica, and to reorder the samples in the diagonal of matrix C to obtain the diagonal elements of a matrix Cᵣ, as defined above in equation (10).

A code modulated signal transmitted by a GPS satellite 29 is received by the GPS receiver 20 and buffered in the input buffer 22. The samples are then provided as input signal vector S to the RAM 31 of the matched filter 30.

The samples in the RAM 31 are forwarded sequentially via multiplier 32 to the processing element 33 in an order determined by the index generators 36. The order is defined by the reordering matrices Rᵢₒᵤₜ and Rᵢᵢₙ comprised in above equation (2), with i=1 for the first DIF FFT stage. The multiplier 32 is simply passed without any multiplications being performed, as no second input is provided at this point of time.

The processing element 33 applies a butterfly operation on the received samples on-the-fly in the form of the right matrix defined above in equations (3) and (4) by way of example for radix-2 and radix-4 butterflies, respectively. The operations are pipelined on the data level.

The resulting samples are provided to the second multiplier 34. The second multiplier 34 multiplies the received samples elementwise with coefficients received from the ROM 35 under control of the index generators 36. The coefficients are in the form of the diagonal entries of a diagonal matrix as defined above in equations (3) and (4) by way of example for radix-2 and radix-4 butterflies, respectively. That is, the coefficients are 1, Wₙ^{k}, W_{N}^{2k}, W_{N}^{3k} etc.

The resulting samples correspond to samples to which the first stage matrix T₁ of a DIF FFT has been applied. They are stored again in the RAM 31.

The same procedure is repeated for all other stages i, with i=2 to n, of the DIF FFT based on the respectively stored samples in the RAM 31. In each stage, another stage matrix Tᵢ is applied to the stored samples. It has to be noted that the last stage Tₙ is mutliplierless. This means, in this last stage n, the second multiplier 34 does not receive any coefficients from the ROM 35 and performs thus no multiplications, but forwards the received samples directly to the RAM 31. To the samples in the RAM 31, by now the last part TₙTₙ₋₁ . . . T₁·S of above equation (12) has been applied.

The samples resulting in the last stage n of the DIF FFT are provided from the RAM 31 to the first multiplier 32 in the order determined by the index generators 36. The order is defined by the reordering matrices R′ᵢᵢₙ and R′ᵢₒᵤₜ comprised in above equation (6), with i=1 for the first DIF FFT stage. The index generation is a function of the transform stage and is shared for both, FFT and IFFT. A stage counter, which is used as an input for data index generation within the stage, is used in two modes. In a first mode, it counts upwards for the FFT, and in a second mode, it counts downwards for the IFFT. This is due to the fact the order of matrices is reversed after transposing the FFT factorization for the IFFT.

The first multiplier 32 multiplies the received samples elementwise with the entries in the diagonal of the diagonal matrix Cᵣ, which are provided at this point of time by the FFT replica generator 23 to a second input of the first multiplier 32.

Thereafter, the processing element 33 applies a butterfly operation on the received samples in the form of the right matrix defined above in equations (7) and (8) by way of example for radix-2 and radix-4 butterflies.

The resulting samples are passed on without any multiplications by the second multiplier 34 and stored again in the RAM 31.

The combination of the selection of a specific order of the samples by the index generator 36, the multiplication by the first multiplier 32 and the butterfly operation by the processing element 33 realize the amended first stage matrix \tilde{T}′ₙ, of the IFFT in above equation (12). To the samples in the RAM 31, thus by now the last part \tilde{T}′ₙ·TₙTₙ₋₁ . . . T₁·S of above equation (12) has been applied.

The samples in the RAM 31 are then provided for each remaining DIF IFFT stage i, with i=2 to n, in a first step to the first multiplier 32.

The first multiplier 32 multiplies the received samples elementwise with coefficients received from the ROM 35 under control of the index generators 36. The coefficients correspond to the entries in the diagonal of a diagonal matrix defined by way of example for radix-2 and radix-4 butterflies in equations (7) and (8), i.e. 1, W_{N}^{-k}, W_{N}^{-2k}, W_{N}^{-3k} etc.

The resulting samples are provided to the processing element 33, which applies a butterfly operation on the received samples in the form of the left matrix defined above by way of example in equations (7) and (8) for radix-2 and radix-4 butterflies.

The samples resulting in the respective IFFT stage in the butterfly operation are forwarded again by the second multiplier 34 for storage in the RAM 31 and used as basis for the respective next IFFT stage.

The samples resulting in the last IFFT stage n are not stored in the RAM 31, but provided as output of the matched filter 30.

The output of the matched filter 30 can then be used in the GPS receiver 20 in a known way for the final acquisition of the received satellite signal.

By the shared use of the RAM 31 for the FFT, for the multiplications with the replica and for the IFFT, by the shared use of a single processing element 33 for all butterfly operations and by the shared use of a single multiplier 32 for the IFFT multiplications and for the multiplications with replica samples, an optimized matched filter is obtained.

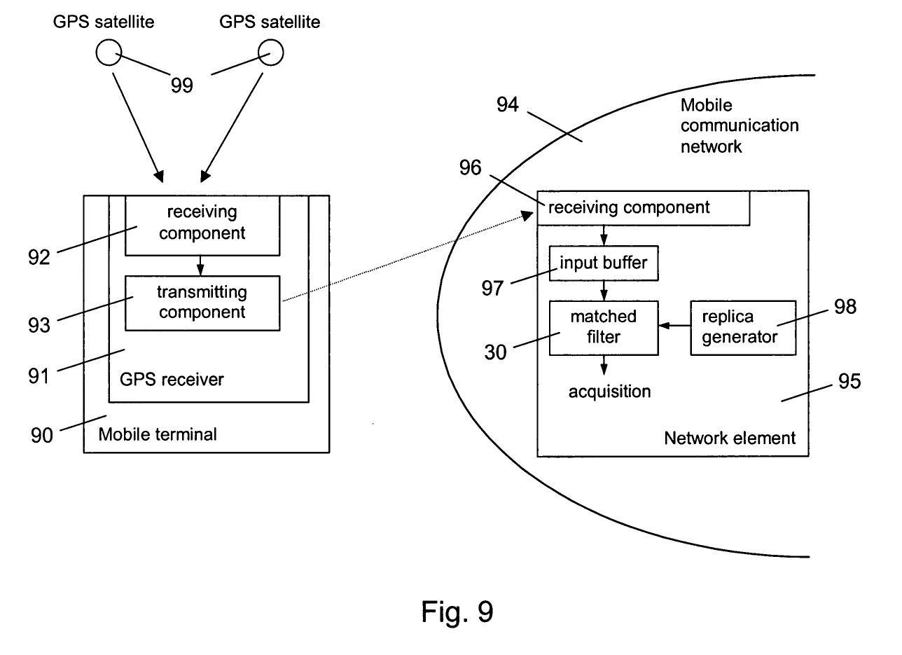

The described matched filter 30 could equally be employed in various other devices and systems. FIG. 9 presents by way of example a mobile communication system in which the matched filter could be used alternatively.

The mobile communication system comprises a mobile terminal 90 and a mobile communication network 94, which are able to communicate with each other in a well known manner. The mobile terminal 90 includes a GPS receiver 91 with a receiving component 92 for receiving code modulated signals from GPS satellites 99 and with a transmitting component 93 for transmitting samples of received signals via the communication functionality of the mobile terminal 90 to the mobile communication network 94. The mobile communication network 94 comprises a network element 95 with a receiving component 96 for receiving samples of a code modulated signal from the GPS receiver 91, an input buffer 97 for storing the input samples, an FFT replica generator 98 for generating a replica code sequence, and the matched filter 30 for performing a correlation between input samples from the input buffer 97 and samples provided by the FFT replica generator 98.

The operation of the matched filter 30 in the network element 95 is the same as the operation of the matched filter 30 in the GPS receiver 20 of FIG. 2, except that the input samples are provided in this case by the input buffer 97 of the network element 95 and that the reordered conjugate of the replica FFT is provided by the FFT replica generator 98 of the network element 95.

While there have been shown and described and pointed out fundamental novel features of the invention as applied to a preferred embodiment thereof, it will be understood that various omissions and substitutions and changes in the form and details of the devices and methods described may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A device for determining in the frequency domain the correlation between a code modulated signal and a replica code sequence in parallel for various relative shifts between said code modulated signal and said replica code sequence, said device comprising a common memory arranged for storing in sequence different intermediate results in determining said correlation, said intermediate results including at least samples resulting at various stages of a time to frequency transform used for transforming samples of said code modulated signal into the frequency domain and samples resulting at various stages of a frequency to time transform used for transforming obtained correlation results into the time domain.

2. The device according to claim 1, wherein said memory is further arranged for storing samples of said code modulated signal before storing said intermediate results.

3. The device according to claim 1, further comprising a multiplier for multiplying one of a reordered conjugate of time to frequency transformed samples of said replica code sequence and reordered time to frequency transformed samples of an inverted replica code sequence to said time to frequency transformed samples of said code modulated signal in order to obtain said correlation results.

4. The device according to claim 1, wherein said time to frequency transform is a Fast Fourier Transform and wherein said frequency to time transform is an Inverse Fast Fourier Transform.

5. The device according to claim 1, wherein said time to frequency transform is a Decimation-In-Frequency Fast Fourier Transform and wherein said frequency to time transform is a Decimation-In-Frequency Inverse Fast Fourier Transform, said device further comprising:
a processing element for performing a respective butterfly operation for all stages of said Decimation-In-Frequency Fast Fourier Transform and of said Decimation-In-Frequency Inverse Fast Fourier Transform;
a first multiplier connected between an output of said memory and an input of said processing element for multiplying samples to be input to said processing element for a respective stage of said Inverse Fast Fourier Transform with coefficients provided for said respective stage of said Decimation-In-Frequency Inverse Fast Fourier Transform;
a second multiplier arranged between an output of said processing element and an input of said memory for multiplying samples output by said processing element for a respective stage of said Decimation-In-Frequency Fast Fourier Transform with coefficients provided for said respective stage of said Decimation-In-Frequency Fast Fourier Transform; and
an index generator for determining for each stage of said Decimation-In-Frequency Fast Fourier Transform and said Decimation-In-Frequency Inverse Fast Fourier Transform the respective order of samples provided from said memory to said processing element.

6. The device according to claim 5, further comprising a second memory for providing said coefficients required for all stages of said Decimation-In-Frequency Inverse Fast Fourier Transform to said first multiplier and for providing said coefficients required for all stages of said Decimation-In-Frequency Fast Fourier Transform to said second multiplier.

7. The device according to claim 5, wherein said first multiplier is arranged in addition for multiplying one of a reordered conjugate of time to frequency transformed samples of said replica code sequence and reordered time to frequency transformed samples of an inverted replica code sequence to said Fast Fourier transformed samples of said code modulated signal in order to obtain said correlation results.

8. The device according to claim 5, wherein said second multiplier is arranged in addition for multiplying one of a reordered conjugate of time to frequency transformed samples of said replica code sequence and reordered time to frequency transformed samples of an inverted replica code sequence to said Fast Fourier transformed samples of said code modulated signal in order to obtain said correlation results.

9. The device according to claim 1, wherein said device is a matched filter.

10. The device according to claim 1, wherein said device is a receiver comprising in addition a receiving component for receiving a code modulated signal from a beacon and a replica generator for generating said replica code sequence.

11. The device according to claim 1, wherein said device is a mobile terminal including a receiver receiving said code modulated signals from a beacon.

12. The device according to claim 1, further comprising a receiving component for receiving samples of said code modulated signal from a receiver receiving said code modulated signal from a beacon and a replica generator for generating said replica code sequence.

13. The device according to claim 12 wherein said device is a network element of a communication network.

14. A system for determining in the frequency domain the correlation between a code modulated signal and a replica code sequence in parallel for various relative shifts between said code modulated signal and said replica code sequence, said system comprising:
a receiver with a receiving component for receiving a code modulated signal from a beacon and with a transmitting component for providing samples of said code modulated signal;
a device with a receiving component for receiving samples of a code modulated signal provided by said receiver and a common memory arranged for storing in sequence intermediate results in determining said correlation, said intermediate results including at least samples resulting at various stages of a time to frequency transform used for transforming samples of said code modulated signal into the frequency domain and samples resulting at various stages of a frequency to time transform used for transforming obtained correlation results into the time domain.

15. A method for determining in the frequency domain the correlation between a code modulated signal and a replica code sequence in parallel for various relative shifts between said code modulated signal and said replica code sequence, said method comprising:
a) applying a time to frequency transform on samples of said code modulated signal for transforming said samples of said code modulated signal into the frequency domain, and storing intermediate results resulting at various stages of said time to frequency transform in a memory; and
b) applying a frequency to time transform on obtained correlation results for transforming said obtained correlation results into the time domain, and storing intermediate results resulting at various stages of said frequency to time transform in said same memory.

16. The method according to claim 15, further comprising
reordering a one of a conjugate of time to frequency transformed samples of said replica code sequence and time to frequency transformed samples of an inverted replica code sequence in order to avoid the necessity of reordering the output of said time to frequency transform of step a) and the input of said frequency to time transform of step b); and
multiplying said reordered conjugate of time to frequency transformed samples of said replica code sequence or said reordered time to frequency transformed samples of an inverted replica code sequence to said time to frequency transformed samples of said code modulated signal in order to obtain said correlation results.

17. A software program product in which a software code is stored for determining in the frequency domain the correlation between a code modulated signal and a replica code sequence in parallel for various relative shifts between said code modulated signal and said replica code sequence, said software code realizing the following steps when running in a processing unit:
a) applying a time to frequency transform on samples of said code modulated signal for transforming said samples of said code modulated signal into the frequency domain, and storing intermediate results resulting at various stages of said time to frequency transform in a memory; and
b) applying a frequency to time transform on obtained correlation results for transforming said obtained correlation results into the time domain, and storing intermediate results resulting at various stages of said frequency to time transform in said same memory.
